(19) United States
(12) Patent Application Publication
(10) Pub. No.: US 2017/0050118 A1
(43) Pub. Date: Feb. 23, 2017

(54) MOLDS AND MOLD SECTION APPARATUSES AND METHODS OF MAKING A SCULPTURE WITH NATURAL MATERIALS

(71) Applicant: Snow Creations, LLC, Loveland, OH (US)

(72) Inventors: Brian LaDuke, Strongsville, OH (US); Oscar Meyer, Loveland, OH (US)

(73) Assignee: Snow Creations, LLC, Loveland, OH (US)

(21) Appl. No.: 15/226,690

(22) Filed: Aug. 2, 2016

Related U.S. Application Data
(60) Provisional application No. 62/200,285, filed on Aug. 3, 2015.

(51) Int. Cl. A63H 33/00; B44C 5/00

(52) U.S. Cl. CPC A63H 33/001; B44C 5/00

(57) ABSTRACT

The present application discloses a mold having a base section having a base width, a base first opening, and a base second opening, and at least one intermediate section having an intermediate width, and an intermediate second opening, wherein the intermediate width is less than the base width and the at least one intermediate section is detachably attached to the base section with one or more fastening structures.

### CLAIM OF PRIORITY

This application is a non-provisional application claiming the benefit of priority under 35 U.S.C. §119(e) of U.S. Provisional Application 62/200,285 filed on Aug. 3, 2015.

### TECHNICAL FIELD

The present application is directed towards a mold apparatus for molding natural materials to make a sculpture. Further, the present application also discusses a method of using the mold apparatus to make a sculpture from natural materials.

### BACKGROUND

Building sculptures with natural materials such as snow or sand is an enjoyable activity that adults and children take part in. Traditionally, sculptures are made by conditioning the natural materials and shaping it in a desired shape, such as a snowman. In the process of conditioning the natural material such as snow or sand into various shapes and placing the conditioned shapes one on top of the other to make a sculpture, it has been observed that when the conditioned natural materials are lifted and placed on top of another shape, the conditioned material may disintegrate. Additionally, it may be difficult to condition natural materials such that they are in proportion with the rest of the shapes being used to make the sculpture. Therefore, there still exists a need to make aesthetically appealing sculptures with natural materials without excessive use of labor.

### SUMMARY

In one embodiment, a mold includes a base section having a base width, a base first opening, and a base second opening, and at least one intermediate section having an intermediate width, and an intermediate second opening. The intermediate width is panels. The hollow structure includes a first opening, a second opening opposite the firstless than the base width and the at least one intermediate section is detachably attached to the base section with one or more fastening structures.

In another embodiment, a mold section includes a hollow structure made of one or more opening, a releasable structure extending from the first opening to the second opening, and at least one of one or more fastening structures placed around the second opening, and one or more securing structures placed around the second opening.

In yet another embodiment, a method of conditioning natural materials for sculpting a sculpture comprises filling a base section with natural materials, the base section having a base releasable structure, attaching the base section to at least one intermediate section using one or more fastening structures, the intermediate section having an intermediate releasable structure, filling the at least one intermediate section with natural materials, and disengaging the base releasable structure and intermediate releasable structure to reveal a sculpture.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a three-tier mold apparatus, where a base section is connected to an intermediate section and the intermediate section is connected to a crown section, according to one or more embodiments shown and described herein;

FIG. 2 depicts a mold section, according to one or more embodiments shown and described herein;

FIG. 3 is detailed view of a releasable structure of the mold section, according to one or more embodiments shown and described herein;

FIG. 4 depicts a filament as placed within the mold section of FIG. 2, according to one or more embodiments shown and described herein;

FIG. 5 depicts the filament of FIG. 4, according to one or more embodiments shown and described herein;

FIG. 6 depicts the crown section connected to the intermediate section using crown fastening structures, according to one or more embodiments shown and described herein; and

FIG. 7 depicts a cylindrical base section, and a conical intermediate section, according to one or more embodiments shown and described herein;

FIG. 8 depicts a cylindrical base section and a frustoconical intermediate section, according to one or more embodiments shown and described herein;

FIG. 9 depicts a cylindrical base section, a cylindrical intermediate section, and a cylindrical crown section, according to one or more embodiments shown and described herein;

FIG. 10 depicts a cylindrical base section, a frustoconical intermediate section, and a half-spherical crown section, according to one or more embodiments shown and described herein;

FIG. 11A depicts mold sections with a first pre-cut pattern, according to one or more embodiments shown and described herein;

FIG. 11B depicts the mold section having a second pre-cut pattern, according to one or more embodiments shown and described herein;

FIG. 11C depicts the mold section having a third pre-cut pattern, according to one or more embodiments shown and described herein;

FIG. 12A depicts mold sections with template portions, according to one or more embodiments shown and described herein;

FIG. 12B depicts various templates, according to one or more embodiments shown and described herein;

FIG. 13 depicts various engraved blocks that are used to decorate a finished sculpture formed by the mold sections, according to one or more embodiments shown and described herein;

FIG. 14A depicts a base section, an intermediate section, and a crown section, according to one or more embodiments shown and described herein;

FIG. 14B depicts a base section, an intermediate section, and a crown section having various accessories, according to one or more embodiments shown and described herein;

FIG. 14C depicts various accessories, according to one or more embodiments shown and described herein;

FIG. 15A depicts a base section, an intermediate section, and a crown section and accessories used to form a snowman, according to one or more embodiments shown and described herein;

FIG. 15B depicts a base section, an intermediate section, and a crown section and accessories used to form a snowman, according to one or more embodiments shown and described herein;

FIG. 16A depicts a base section and an intermediate section used to form a sitting man, with various accessories, according to one or more embodiments shown and described herein;

FIG. 16B depicts a type of accessory, according to one or more embodiments shown and described herein;

FIG. 16C depicts a template, according to one or more embodiments shown and described herein; and

FIG. 17 is a flowchart depicting a method of making a sculpture from natural material using the mold apparatus of FIG. 1.

### DETAILED DESCRIPTION

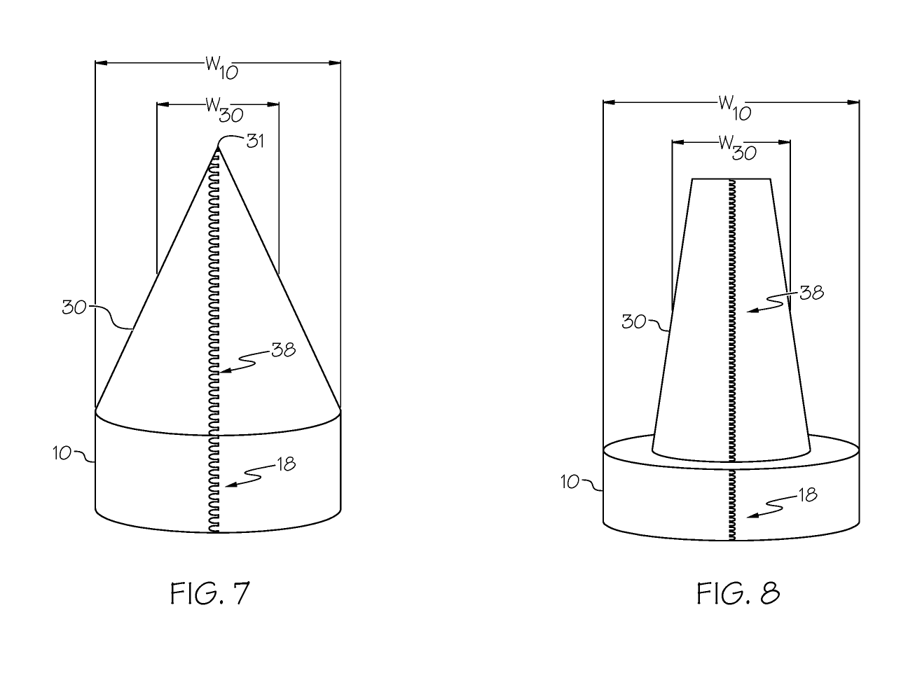

Embodiments described herein generally relate to a mold apparatus used to condition various natural materials to make a sculpture. Referring generally to FIGS. 7-10, an apparatus having one or more mold sections is shown. The apparatus is used to form a sculpture made of conditioned natural materials. The apparatuses include a base section and at least one intermediate section. The base section is filled with natural materials, and the at least one intermediate section is placed on the base section. The at least one intermediate section is also filled with natural materials. The base section and the at least one intermediate section are removed from the conditioned natural materials within the mold section using releasable structures to reveal a sculpture of conditioned natural materials.

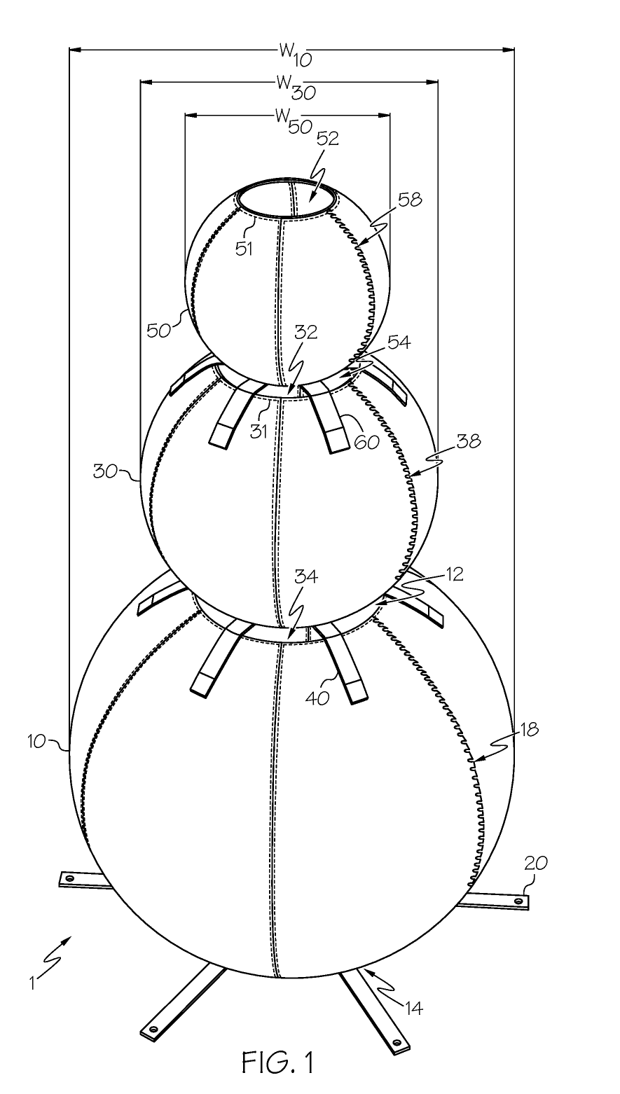

As shown in FIG. 1, an apparatus of mold 1 may be used to condition various natural materials to make an in situ sculpture. As used herein, “natural materials” refer to any material that comes from the ground, or surface of the earth. For example, natural materials may include sand, snow, mud, etc. Water may be added to natural materials to allow for an optimal consistency to permit its molding.

In the exemplary embodiment shown in FIG. 1, a mold 1 includes a base section 10, at least one intermediate section 30, and a crown section 50. The base section 10 is detachably attached to the at least one intermediate section 30 with one or more fastening structures 40, and the at least one intermediate section 30 is detachably attached to the crown section 50 with one or more fastening structures 60. As a non-limiting example, the mold sections 10, 30, 50 of the mold 1 have different sizes (or volumes), where the base section 10 is the largest in size, the intermediate section 30 is smaller than the base section 10, and the crown section 50 is the smallest, to build a three-tiered sculpture. While FIG. 1 shows the various mold sections 10, 30, 50 arranged in descending order of sizes (from bottom to top), in embodiments, the order of the placement of the various mold sections 10, 30, 50 may be changed.

Still referring to FIG. 1, the base section 10 has a base first opening 12 and a base second opening 14, the openings 12, 14 placed at opposite ends of the base section 10, and a base width W10. Further, the at least one intermediate section 30 has an intermediate first opening 32 and an intermediate second opening 34, the openings 32, 34 placed at opposite ends of the intermediate section 30. The intermediate section 30 has an intermediate width W30 which is less than the base width W10. In embodiments, the intermediate second opening 34 is placed on top of the base first opening 12. The at least one intermediate section 30 may be detachably attached to the base section 10 with the one or more intermediate fastening structures 40.

Further, as shown in FIG. 1, the crown section 50 is placed on top of the at least one intermediate section 30. The crown section 50 has a crown first opening 52 and a crown second opening 54 at opposite ends of the crown section 50, and a crown width W50, such that the crown width W50 is less than the intermediate width W30. As shown in FIG. 1, the crown second opening 54 is placed over the intermediate first opening 32. Further, the crown section 50 may be detachably attached to the at least one intermediate section 30 with the one or more fastening structures 60.

Still referring to FIG. 1, the base section 10 is secured to the surface (i.e. the ground where the sculpture is being made) using one or more securing structures 20. In embodiments, a base releasable structure 18 extending between the base first opening 12 and the base second opening 14, an intermediate releasable structure 38 extending from an intermediate top 31 of the at least one intermediate section 30 to the second opening 34 of the at least one intermediate opening, and a crown releasable structure 58 extending from a crown top 51 to the crown second opening 54 of the crown section 50, are provided. The releasable structures 18, 38, 58 may be aligned with each other to form an aligned line of release extending from the crown section 50 to the base section 10.

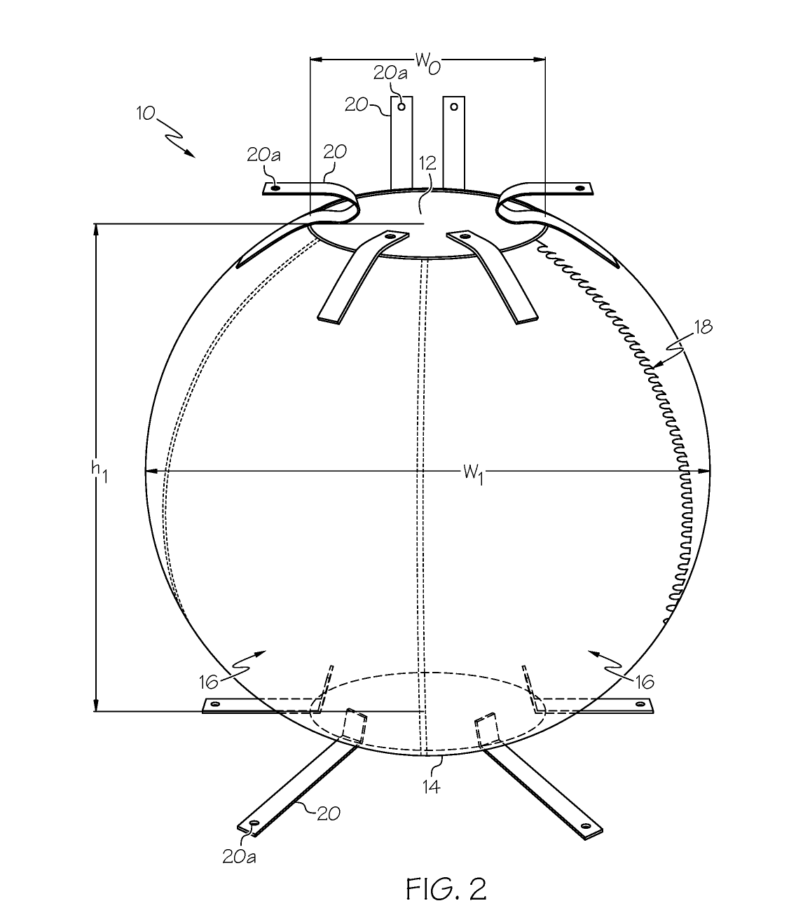

Referring now to FIG. 2, the base section 10 (also referred to as mold section 10) as shown in FIG. 1 is further described in isolation. While the base section 10 is particularly described herein, the at least one intermediate section 30 and the crown section 50 may include some or all of the features discussed with respect to the base section 10.

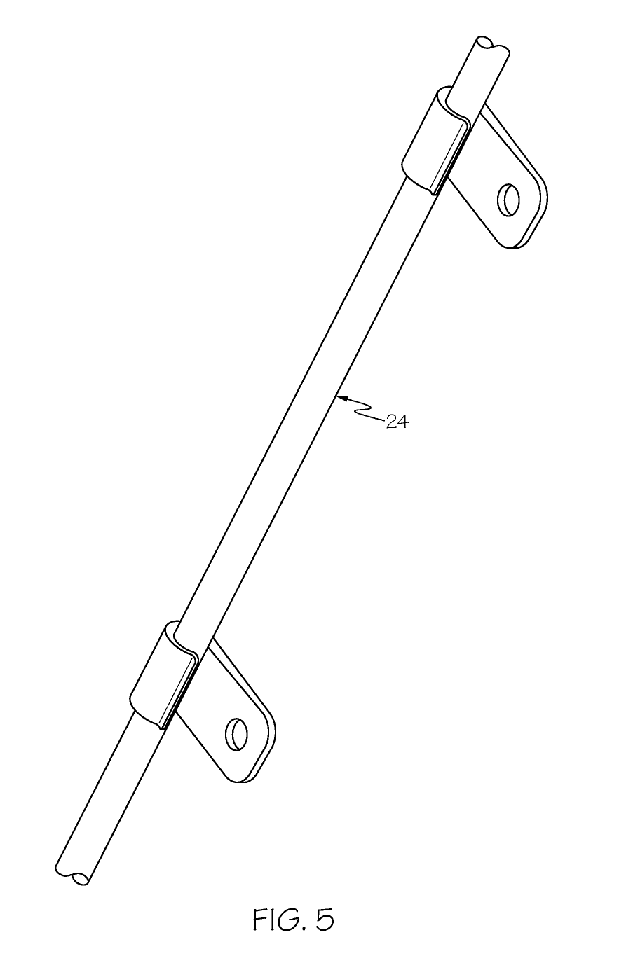

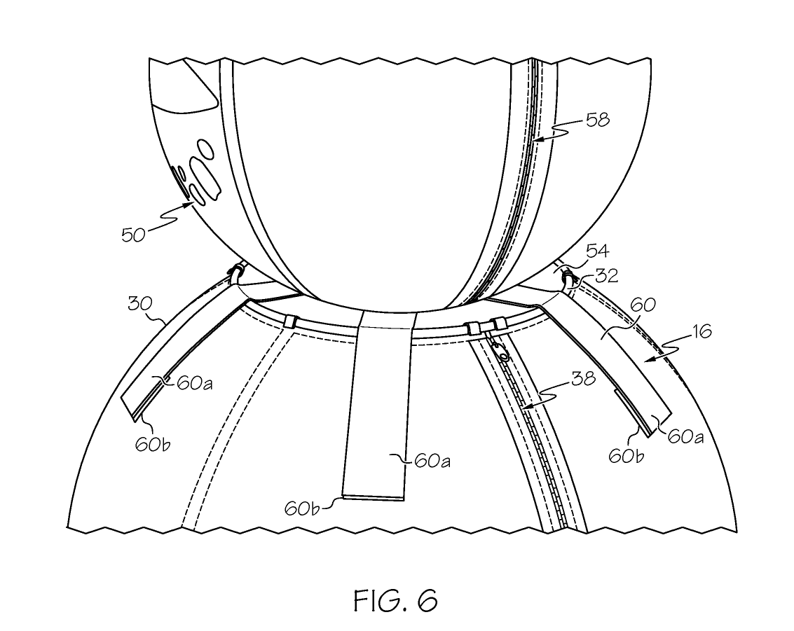

As depicted in FIG. 2, in one exemplary embodiment, the mold section 10 is a hollow structure made of one or more panels 16. The mold section 10 includes a first opening 12, a second opening 14 opposite the first opening 12. Further the mold section 10 includes a releasable structure 18 extending from the first opening 12 to the second opening 14. The mold section 10 also includes at least one of one or more fastening structures 40 placed at or around the second opening 14 (as shown in FIG. 6) and one or more securing structures 20 placed at or around the second opening 14. While FIG. 2 depicts the mold section 10 as a hollow sphere, the mold sections 10 may be of various shapes, such as a cube, cuboid, hemisphere, cylinder, cone, or pyramid.

In one embodiment, the height h1 of the mold section 10 is the vertical length of the mold section 10 when measured from its first opening 12 to its second opening 14. The mold section 10 also has a width W1 that is measured through a central axis of the base section 10 and perpendicular to the height h1 of the base section 10. In some embodiments, the width W1 and height h1 may be about the same. In other embodiments, the width W1 and height h1 may be different. In embodiments, where the mold section 10 is a sphere, as shown in FIG. 2, the width W1 is a diameter of the spherical mold section 10, and in some embodiments, may the width W1 may also be a maximum diameter of the mold section. In exemplary embodiments, the W1 may also be a maximum width of the mold section 10, and taken along an axis that is perpendicular to the height h1 of the mold section 10. Further, in embodiments, the first and second openings 12, 14 may have a width W0. In some embodiments, the width W0 of the first and second openings 12, 14 may be about the same or may be different. In some embodiments, the width W0 may be at least about 10 percent (such as at least about 15 percent, 20 percent, 25 percent, 30 percent, 40 percent, 50 percent) of the width W1 of the hollow structure of the mold section (but less than the width W1). In some embodiments, the width W0 of the first opening 12 may be between 15 percent and 50 percent of the width W1 of the mold section 10.

As shown in FIG. 2, the mold section 10 is made of one or more panels 16. The one or more panels 16, generally, may be connected to each other by means of a suitable permanent connection such as sewing, adhesive, welding or heat sealing. However, at least at one location the one or more panels 16 are connected using the releasable structure 18. In embodiments, the releasable structure 18 may be detachably attached. Non-limiting examples of the releasable structure 18 include zippers, buttons, snaps, strings, and the like. Other well-known releasable structures 18 may also be used. In one embodiment, the releasable structure 18 may be placed along a length of the panels 16 between the first opening 12 and the second opening 14.

In exemplary embodiments, the one or more panels 16 are flexible in nature. In embodiments, the flexible panels allow the mold sections 10 to be collapsible or foldable. In embodiments, the one or more panels 16 may be made of fabric material. As used herein, the term “fabric” refers to any flexible material made by weaving, knitting or otherwise connecting individual strands of synthetic or natural fibers. Examples of fibers can comprise any type of flexible material such as polyester and nylon, and various plastic-fabric blends. Plastic-fiber blends may include material having 90% plastic, 10% fiber, or 80% plastic, 20% fiber, or 70% plastic, 30% fiber, or 60% plastic, 40% fiber, or 50% plastic, 50% fiber, or 40% plastic, 60% fiber, or 30% plastic, 70% fiber, or 20% plastic, 80% fiber, or 10% plastic, 90% fiber. In some embodiments, the one or more panels 16 may be formed of a plastic substrate or sheet, plastic woven sheets, or multiple layers of plastic woven sheets that are melted together to form a single sheet. As a non-limiting example, polyethylene sheets may be used to make the one or more panels 16. As other non-limiting examples, various types of tarp material, such as polyurethane tarp, polyethylene tarp, poly tarp, canvas tarp, mesh tarp, fire retardant tarp, silnyon tarp, insulated tarp and the like may be used. Each mold section 10 may have between and including one and nine panels 16. In an exemplary embodiment, the mold section 10 may have one panel 16. In some embodiments, depending on the shape, height and volume of the mold section 10, the mold section 10 may be made of one or more panels 16 that are semi-rigid. In a non-limiting example, when additional support is required by the mold section 10, the one or more panels 16 may be a combination of flexible panels and semi-rigid panels. In one embodiment, all of the one or more panels 16 may be semi-rigid. As an exemplary embodiment, the one or more panels 16 which are semi-rigid are made of soft cardboard.

Mold sections 10 made out of one or flexible panels 16 are more durable as compared to rigid molds that are made out of metal or molded plastic. Further, flexible mold sections 10 as described above are lighter than rigid molds which make them easier to carry and build with. Additionally, mold sections 10 may be collapsible providing for easy shipping or storage when not in use. Due to the flexibility of the panels 16, the mold sections 10 may be collapsible along a vertical length of the mold section 10. Further, the mold section 10 may also be collapsible along a width of the mold section 10. In some embodiments, the mold section 10 is collapsed along the length or width and folded to make storage easier.

The material of the one or more panels 16 allows for sculpting sculptures with all types of natural materials. The one or more panels 16 may be formed as water resistant, hydrophobic, and hydrophilic flexible materials or combinations thereof. For example, in an exemplary embodiment, the one or more panels 16 used in molding snow sculptures may be formed such that the one or more panels 16 prevent the snow from sticking to the one or more panels 16. In one embodiment, a coating may be applied to the one or more panels 16 to minimize adherence to snow. In certain embodiments, the one or more panels 16 used in molding sand sculptures may be heat resistant, and allow for the wet watery sand to drain water, thereby improving the ability to mold the sand into longer lasting shapes. Additionally, the one or more panels 16 are easy to clean and allow for repeated usage of the mold sections 10.

In one embodiment, while the one or more panels 16 may be flexible, they may or may not be elastic. Inelastic panels can maintain a predetermined volume when filled with a natural material. In some embodiments, the one or more panels 16 may be elastic only in one direction. In certain embodiments, the one or more panels 16 can be made of a material that allows the mold sections 10 to be flexible and can be folded flat when not in use. Such an arrangement can allow the mold section 10 to be stored flat, for example in a bag or a box.

Still referring to FIG. 2, the first opening 12 facilitates the easy filling of natural material into the mold section 10. Further, the second opening 14 allows the mold section 10 to rest flatly on a surface, or on another mold section 10. In one embodiment, when the mold section 10 is being placed on a surface (and not on another mold section 10), one or more securing structures 20 may be provided at or around at least the second opening 14 to secure or anchor the base section 10 to the surface (i.e. on which the sculpture is being made). As shown in FIG. 2, in some example embodiments, one or more securing structures 20 may be provided at or around both the first opening 12 and the second opening 14. In other exemplary embodiments, the one or more securing structures 20 may be placed along the height of the one or more panels 16. In the exemplary embodiments shown in FIG. 2, the one or more securing structures 20 include at least two securing strips that are arranged either across or around the second opening 14. The end of each securing strip 20 further comprises an eyelet 20a. The eyelets 20a allow for anchoring the base mold segment 10 to the surface. Non-limiting examples of the eyelets 20a include sewn loops, heat sealed holes, metal grommets, and the like. In one embodiment, the eyelets 20a are used to drive stakes into the surface to ensure securing of the base mold section. In some exemplary embodiments, the one or more securing structures 20 and eyelet 20a are staking straps with stake openings.

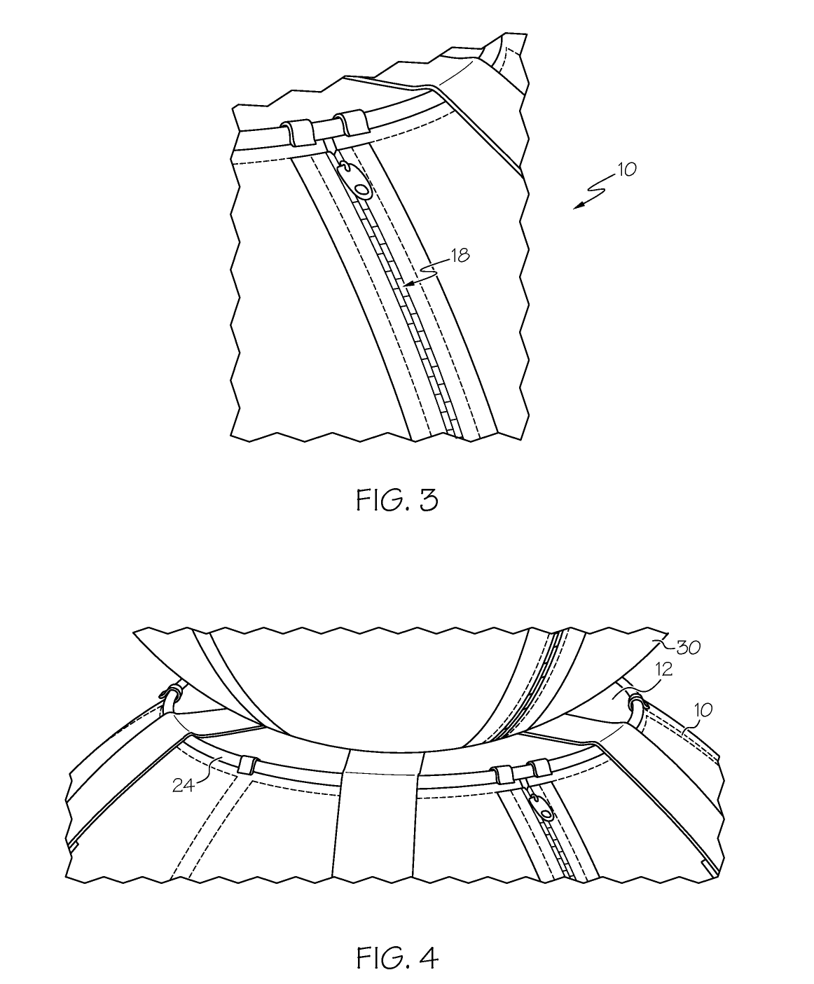

Referring to FIG. 2, the releasable structure 18 extends from and between the first opening 12 and the second opening 14. The releasable structure 18 assists in maintaining the shape of the mold section 10. That is, when the releasable structures 18 are detachably attached or engaged, the mold section 10 can be filled with natural materials from the base first opening 12. After the mold section 10 is sufficiently packed with natural material, the releasable structures 18 are disengaged to reveal conditioned natural material within. Further, once the releasable structure 18 is detached or disengaged, the mold section 10 is collapsible, making it easy for storage. Briefly referring to FIG. 3, in exemplary embodiments, the releasable structure 18 is a zipper. The zipper may be opened from the base first opening 12 or the base second opening 14 of the mold section 10, i.e. the zipper can move in both directions between the openings 12, 14. Referring back to FIG. 2, other non-limiting examples of the releasable structure 18 include, but are not limited to hook and loop structures, snaps, buttons, thread or string, magnets and the like. In one embodiment, a combination of hook and loop structures, snaps, buttons, thread or string, magnets and the like may be used. In certain embodiments, a flap may be provided on the inside of the releasable structure 18 to prevent natural material from getting between the releasable structure 18.

FIG. 4 depicts the mold section 10 of FIG. 2 interconnected with another mold section, showing a filament 24 placed along the base first opening 12. The filament 24 may also be placed around the second opening 14 of the mold section 10. In one embodiment, filament 24 is used to provide structural rigidity to the mold section 10. In some embodiments, the filament 24 may be a plastic tube. In embodiments, the filament 24 is either sewn into the mold section 10 or can be clipped on by the user. In certain embodiments, the monofilament 24 may be held in position by using fabric loops. FIG. 5 shows a filament 24 before it is inserted around the openings 12, 14 of the mold section 10. As a non-limiting example, the filament 24 may be a monofilament. In embodiments, a sewn channel or casing may be provided around the first opening 12 to hold the filament 24. Further, in some example embodiments, the filament 24 may be placed vertically, and extending along the length of the one or more panels 16 to provide support. In some embodiments, the filament may be fixed into the one or more panels 16.

FIG. 6 depicts a crown section 50 detachably attached to the at least one intermediate section 30 by the one or more crown fastening structures 60. Specifically, the one or more fastening structures 60 are used to create a tiered sculpture with ease, because it obviates the need to roll shapes out of natural materials and lift the rolled shaped and to be placed one on top of another. While FIG. 6 specifically discusses the connection of the crown section 50 to the at least one intermediate section 30, the below described features can be used to connect any two mold sections 10.

The one or more fastening structures 60, as shown in FIG. 6, are placed at the crown second opening 54. In this exemplary embodiment, the one or more fastening structures 60 are fastening straps 60a. Each fastening strap 60a further includes connecting members 60b placed on the fastening straps 60a. The connecting members 60b are configured to facilitate a connection between the fastening straps 60a of the crown section 50, with the one or more panels 16 near the intermediate first opening 32 of the at least one intermediate section 30.

As shown in FIG. 6, the one or more fastening structures 60 are placed at the crown second opening 54 such that the fastening straps 60a at or around the crown second opening 54. In exemplary embodiments, the fastening straps 60a radiate out of the crown second opening 54. However, in some embodiments, the one or more fastening structures 60 may also be placed on the at least one intermediate section 30 at or around the intermediate first opening 32 to facilitate a connection between the at least one intermediate section 30 and the crown section 50. In some example embodiments, the fastening straps 60a are placed across the crown second opening 54. In some embodiments, the fastening straps 60a may be permanently fixed onto the crown second opening 54, while in other embodiments, the fastening straps 60a may be detachably attached to the crown second opening 54.

Still referring to FIG. 6, in exemplary embodiments, the fastening straps 60a may be made of the same material as the one or more panels 16. In certain embodiments, the fastening straps 60a may be elastic to allow for proper connection between differently sized mold sections 10, 30, 50. In one embodiment, the fastening straps 60a may be rectangular in shape. Further, in non-limiting example embodiments, between two and six fastening straps 60a are used to connect the crown section 50 to the intermediate section 30. In some embodiments, the connecting members 60b may be placed throughout the fastening strap 60a or may be placed intermittently on the fastening straps 60a. In non-limiting example embodiments, the connecting members 60b may be magnets, Velcro™, D-ring attachments, zippers or a combination thereof. In certain embodiments, the one or more fastening structures 60 may also be provided with a gripper to allow the user to easily hold onto and detach/attach the straps 60a from the panels 16 of the intermediate section 30. In one embodiment, the one or more fastening structures 60 are designed in such a way that the connection of the crown section 50 with the at least one intermediate section 30 also facilitates the alignment of the intermediate releasable structures 38 and the crown releasable structures 58. This alignment of the releasable structures 38, 58 ensures easy removal of the mold sections 30, 50 from the molded sculpture within. In other example embodiments, the one or more fastening structures 60 may be zippers, hook and loop tape, snaps and the like.

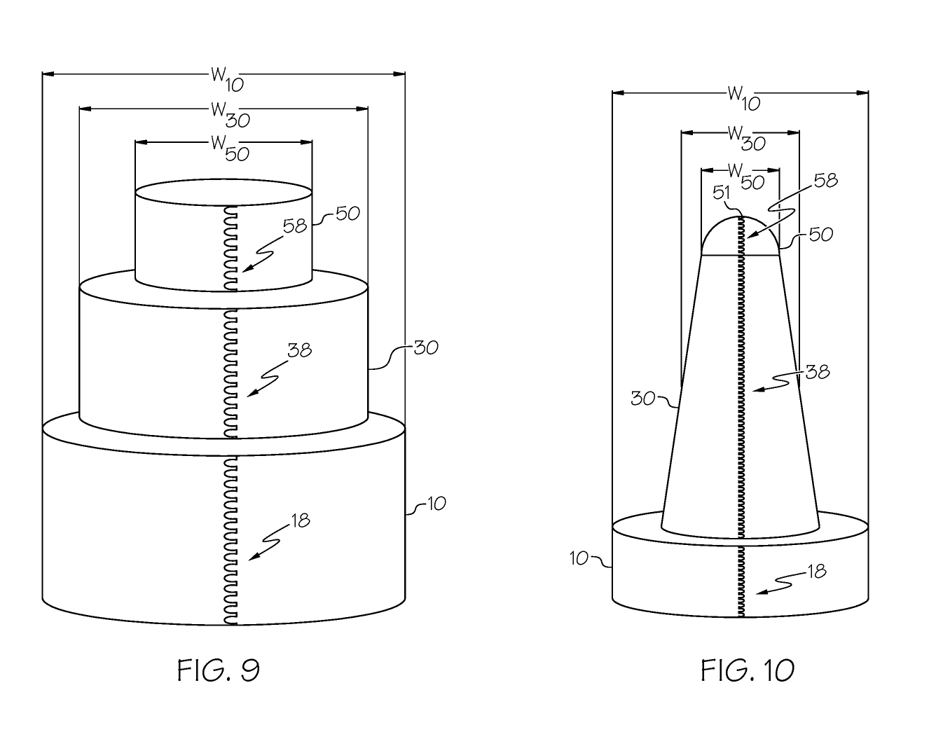

Referring to FIGS. 7-10 collectively, molds 1 with various shapes are depicted as exemplary embodiments. For example, FIG. 7 depicts the base section 10 having a cylindrical shape, and the at least one intermediate section 30 having a conical shape. FIG. 8 shows the base section 10 having a cylindrical shape, and the at least one intermediate section 30 having a frusto-conical shape. FIG. 9 shows a three-tier mold 1 where each of the base section 10, the at least one intermediate section 30, and the crown section 50 each having a cylindrical shape with varying widths. FIG. 10 depicts the base section 10 having a cylindrical shape, the at least one intermediate section 30 having a frusto-conical shape 30 and the crown section 50 having a shape of half a sphere.

Referring to FIGS. 7-10 collectively, each of the base sections 10 is shown to have the base width W10, and the at least one intermediate sections 30 have an intermediate width W30, where the intermediate width W30 is less than the base width W10. In embodiments, the base width W10, and the at least one intermediate width W30 is the width of the mold section 10, 30 measured at a central axis of each mold section 10, 30 and perpendicular to the height of the mold section 10, 30. In exemplary embodiments, the base width W10 and the intermediate width W30, may be the maximum width of that mold section 10, 30 measured along an axis perpendicular to the height of the mold section 10, 30. In other exemplary embodiments, the at least one intermediate section 30 may have one or more dimensions that are less than a one or more dimensions of the base section 10. Non-limiting examples of the one or more dimensions may include surface area, volume, diameter, height, and the like. For instance, as a non-limiting example, the at least one intermediate section 30 may have a volume that is less than a volume of the base section 10. Further, when three mold sections 10, 30, 50 are used, the crown section 50 may have a volume less than the at least one intermediate section 30, which may have a volume less than the base section 10. In exemplary embodiments, different combinations from those depicted in FIGS. 7-10 of base sections, intermediate sections and crown sections may also be used.

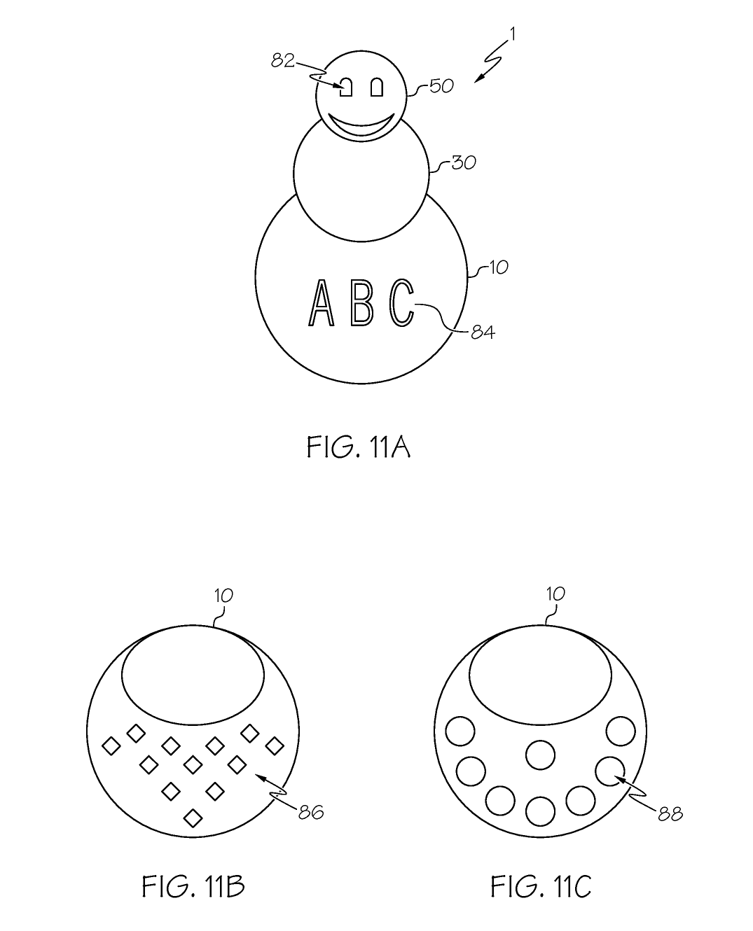

Referring to FIGS. 11A-C, pre-cut mold sections may be used, where pre-cut patterns, 82, 84, 86, 88 may be present on a surface of the mold sections 10, 50 as shown in FIGS. 11A-C. Pre-cut patterns on the mold sections 10, 30, 50 include patterns, shapes, designs or text cut into the mold sections 10, 30, 50 to produce the cut design on the natural materials molded within the mold sections 10, 30, 50. The pre-cut patterns 82, 84, 86, 88 are portions of the mold section 10, 50 that are holes, cavities or apertures made into the mold section material. In some embodiments, pre-cut patterns 82, 84, 86, 88 may be present on all mold sections 10, 30, 50 of the mold 1. Using pre-cut molds 10, 30, 50, various patterns which are negative impressions or “shadow” of the pre-cut patterns may be formed on the sculpture as natural materials are being filled in the mold 1. That is, on releasing the mold sections 10, 30, 50 from the molded natural materials within, the sculpture formed is be formed with the negative impressions of patterns 82, 84, 86, 88 on mold section 10, 50 as shown in FIG. 11A. Further, FIGS. 11B and 11C are non-limiting exemplary embodiments of mold sections 10 having different pre-cut patterns 86, 88. In embodiments, color may be used to depict outlines of the pre-cut patterns 82, 84, 86, 88 using color sprays or color powder to color the natural materials before the pre-cut mold sections 10, 30, 50 are released from the molded natural materials within.

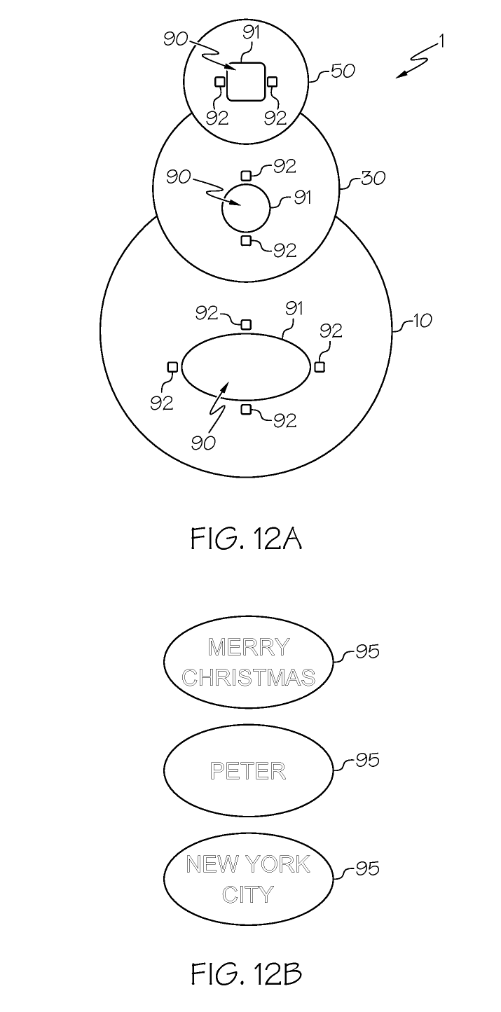

Referring now to FIGS. 12A-B, mold sections 10, 30, 50 may have template portions 90. The template portions 90, as shown in FIG. 12A includes a template affixing area 91 and template affixing members 92. The template affixing areas 91 may be holes that may or may not have a same shape as templates 95 formed on the mold sections 10, 30, 50. That is, the template affixing areas 91, in embodiments expose the natural material (without cover) filled within the mold section 10, 30, 50. Templates 95, as shown in FIG. 12B may be affixed on the template affixing area 91 of the mold sections 10, 30, 50. Templates 95 may be made of any flexible material, and in some embodiments may be made of the same material as the mold sections 10, 30, 50, or alternatively, could be made of a thin sheet of cardboard, plastic or metal. The templates 95 may have pre-cut patterns which include patterns, shapes, designs or text cut into the templates 95 to produce the cut design on the natural materials molded within the mold sections 10, 30, 50 when the templates 95 are placed on the mold sections 10, 30, 50. FIG. 12B shows exemplary templates 95 with text on them, however templates 95 may even have various pre-cut designs formed on them. Templates 95 are placed on the mold sections 10, 30, 50 such that the pre-cut text or design on the templates 95 may be formed onto the sculpture as the mold 1 is being filled with natural materials. Templates 95 are affixed on the template affixing areas 91 using the template affixing members 92. In embodiments, non-limiting examples of template affixing members 92 are hook and loop structures, snaps, buttons, thread or string, magnets and the like. Template affixing members 92 may also be placed on an underside of the templates 95. In some embodiments, color, in the form of color spray or color powder may be applied to the natural materials that are exposed through the pre-cut text shape or designs on templates 95 when the templates are affixed on the template portions 90 so that a color contrast between the color of the natural materials and colored text or design from the templates 95 may be seen.

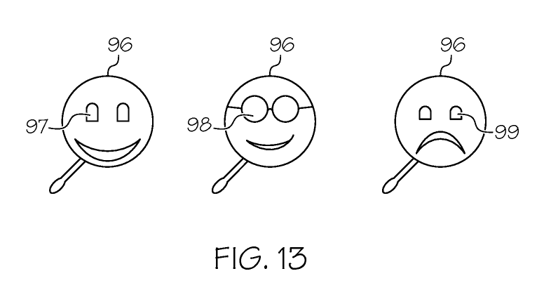

Referring now to FIG. 13, engraved blocks 96 may be used to create various patterns or shapes on a finished sculpture, i.e. after the natural materials have been molded within the mold 1, and the mold sections 10, 30, 50 have been released from the sculpture formed. The engraved blocks 96 may have various texts or patterns created on a base with raised portions. As non-limiting examples shown in FIG. 13, various smiley face shapes may be used to create an impression on the natural materials. In some embodiments, the engraved blocks 96 may be dipped in color before the engraved block 96 is engraved onto the sculpture. Handles may be provided on the engraved blocks 96. In other embodiments, color may be applied using color spray or color powder after the engraved block 96 is engraved onto the sculpture.

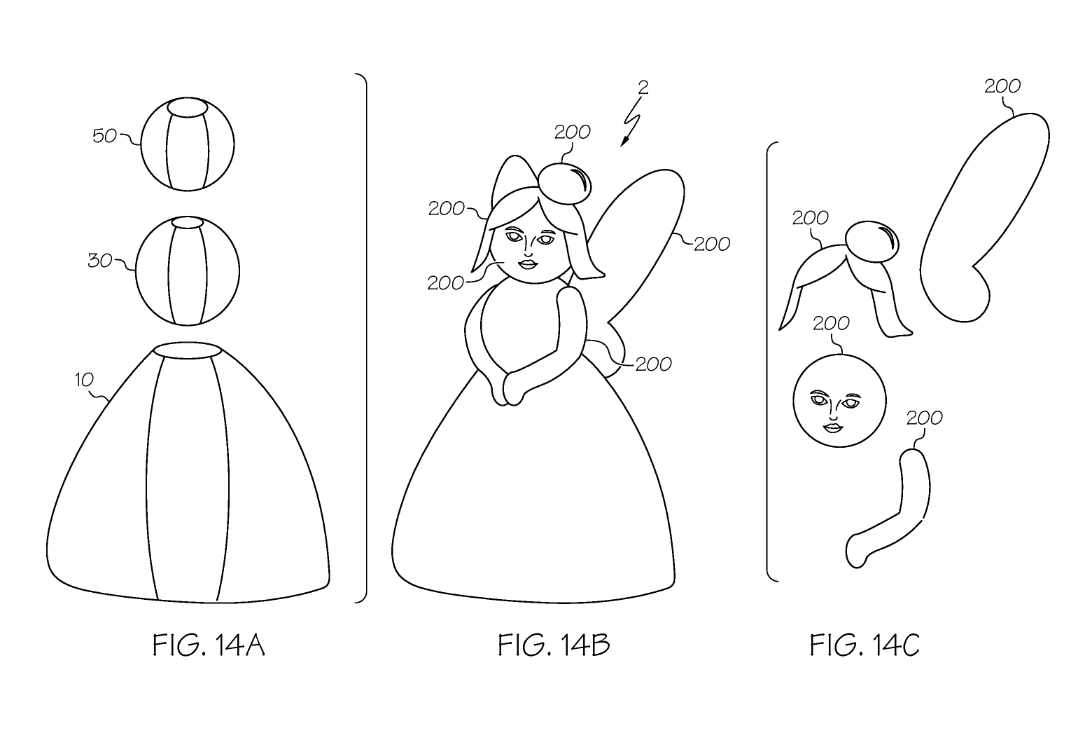

Referring to FIGS. 14-16, sculptures of various characters may be created with the mold 50 are used to form a fairy have been shown in FIGS. 14A-B. As shown in FIG. 14A, the base section 10, the intermediate section 30 and the crown section 50 are used to form a sculpted fairy 2, as shown in FIG. 14B after the mold sections 10, 30, 50 have been filled with natural materials, and released from the sculpture. The intermediate section 30 is smaller in width than the base section 10, and the crown section 50 may be of equal or smaller width than the intermediate section 30. After the mold sections 10, 30, 50 are released from the molded natural materials filled within the mold sections 10, 30, 50, the sculpture may be decorated with various accessories 200. Accessories 200 may be made of plastic or fabric material. Accessories 200 may be used to enhance the appearance of the molded sculpture. Exemplary accessories 200, as shown in FIG. 14C may include wings, a face mask, a wig, a set of hands, a bow or headband, and the like.

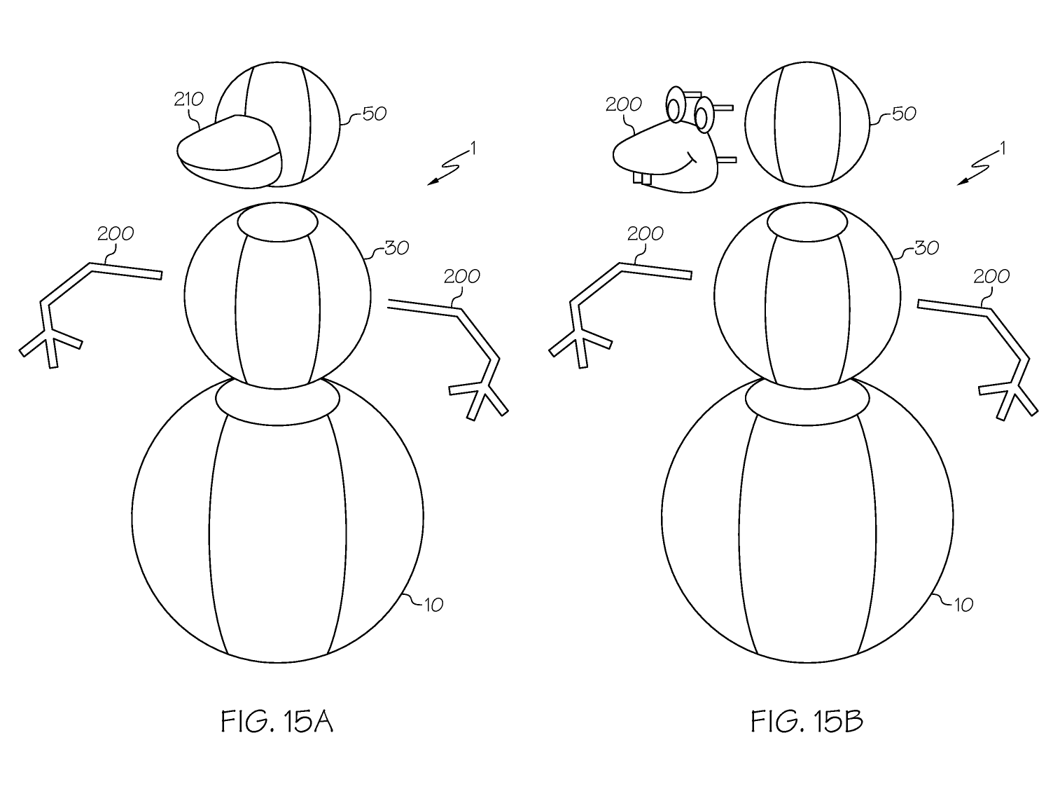

Referring now to FIG. 15A-B a snowman mold is shown having the base mold section 10, the intermediate mold section 30 and the crown mold section 50. With respect to the crown mold section 50, as shown in one an exemplary embodiment of FIG. 15A, a mouth portion 210 may be attached to an opening formed in the crown mold section 50 such that when the crown mold section 50 is filled with natural material, and released, a mouth is molded on the sculpture. Alternatively, as shown in FIG. 15B, an accessory 200, such as a mask may be provided that may be attached to the sculpture after the mold sections 10, 30, 50 have been released. Other accessories 200 such as hands may be provided that are attached to the finished sculpture.

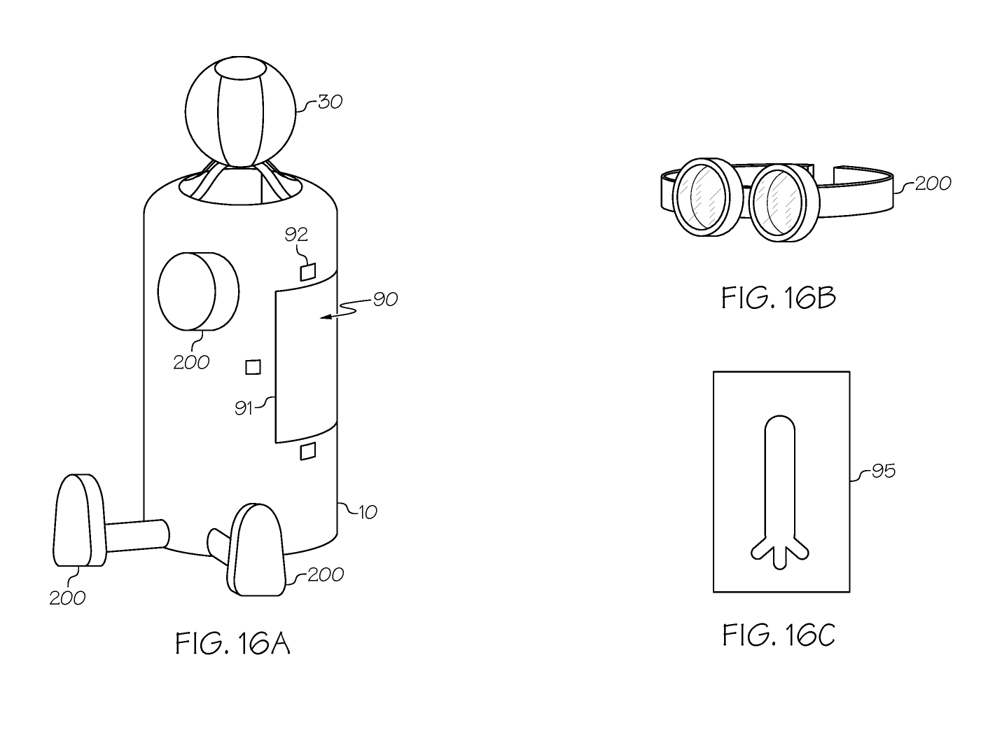

Referring now to FIG. 16A-C, a sitting man with glasses is shown having the base section 10 which is cylindrical in shape, and the intermediate section 30 which is spherical in shape, with a smaller width than the base section 10 is shown. The intermediate section 30 is also shown to have template portions 90, where template 95 shown in FIG. 16C which has a precut design in a shape of a hand may be placed. Further, various accessories 200 such as buttons, glasses (as shown in FIG. 16B), legs, and the like may be used on the finished sculpture so that the sculpture depicts a sitting man with glasses.

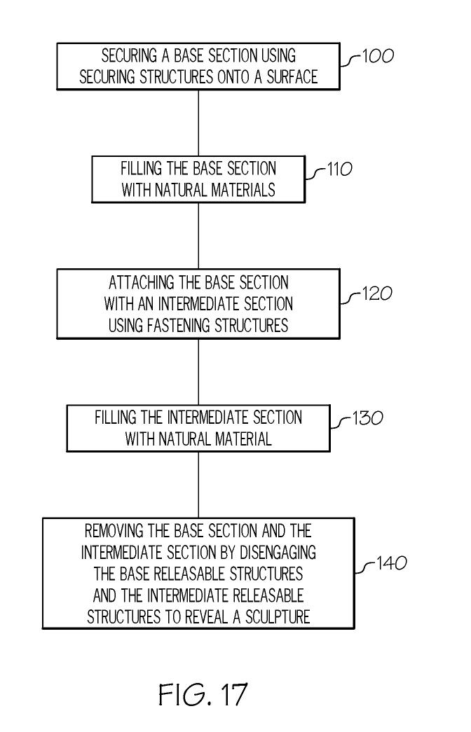

Referring to FIG. 17, a method of conditioning natural materials for molding a sculpture is discussed. Specifically, FIG. 17 discusses a method of building a two-tier sculpture. However, the same method may be used to connect multiple mold sections 10.

Step 100 of FIG. 17 includes securing a base section 10 using one or more securing structures 20 onto a surface (i.e. ground). The base securing structures 20 comprise securing strips 20a as discussed with respect to FIG. 1 above. Each securing strip 20 has eyelets 20a, which are used to anchor the base section 10 to a surface.

At step 110, the base section 10 is filled with natural materials. In this step, it is ensured that the base releasable structures 18 are engaged or detachably attached so that the natural materials may be filled, and held within the base section 10. In one embodiment, a user may fill the natural material into the base section 10 manually. In another embodiment, the user may use tools, such as a spade or a shovel to facilitate filling of the base section 10. Natural material is filled into the base section 10 until the base section 10 is sufficiently packed.

At step 120, the base section 10 is attached with at least one intermediate section 30 using the one or more intermediate fastening structures 40. The mechanism to connect the at least one intermediate section 30 to the base section 10 is the same as discussed above in reference to FIG. 4. In one embodiment, the base section 10 may also be connected to the intermediate section 30 using one or more fastening structures 40, 60 as shown in FIG. 6.

In one embodiment, the connection of the at least one intermediate section 30 to the base section 10 using the one or more fastening structures 40 also aligns base releasable structures 18 with intermediate releasable structures 38. This allows easy removal of the base and intermediate sections 10, 30 from the molded sculpture within.

At step 130, after the intermediate section 30 is connected to the base section 10, natural materials are filled into the intermediate section 30, similar to step 110. In example embodiments, the natural materials may be filled into the mold sections 10, 30 after the at least one intermediate section 30 has been attached to the base section 10.

At step 140, the base section 10 and the at least one intermediate section 30 are removed by disengaging the base releasable structures 18 and intermediate releasable structures 38 to reveal a molded sculpture within.

Further steps may be performed to add additional mold sections 10 on top of the at least embodiment, when a three-tier sculpture is desired, the crown section 50 is further connected to the at least one intermediate section 30, after the intermediate 30 has been filled with natural materials. The crown section 50 is connected to the intermediate section 30 by using the one or more crown fastening structures 60. In this method, after the crown section 50 has been connected to the intermediate section 30, the crown section 50 is filled with natural materials as discussed in steps 110 and 130. After the crown section 50 is sufficiently packed with natural materials, the crown releasable structures 58, the intermediate releasable structures 38, and the base releasable structures 18 are disengaged to reveal a three-tier molded structure within.

Another aspect of the present disclosure entails a sculpture molding kit. The sculpture molding kit comprises at least one mold section 10 and a bag to store the mold sections 10. In addition to these, the sculpture molding kit may further comprise tools to secure the base section 10, and decorations/accessories 200 to enhance the appearance of the molded sculpture after the mold sections 10 have been used.

In one embodiment, a sculpture molding kit comprises between one and four mold sections 10. Each mold section 10 may vary in size and shape. For example, various shapes such as a cube, cuboid, hemisphere, cylinder, cone, pyramid and combinations thereof may be provided in the kit.

Additionally, different sizes of the same shaped mold section 10 may be provided. For example, a kit to make snowman sculptures may comprise a combination of four mold section 10 shaped as hollow spheres, with various sizes: a small mold section having a radius of 125 mm (or 4.92″), a medium mold section having a radius of 200 mm (or 7.87″), a large mold section having a radius of 300 mm (or 11.81″) and an extra-large mold section having a radius of 450 mm (or 17.72″).

The sculpture molding kit further comprises a bag provided to store or carry the mold sections 10. In one embodiment, the bag is made of a light weight material. In some embodiments, the bag is water-proof. Further, in certain embodiments, the bag is large enough to fit between one and four mold sections 10 of different shapes and sizes.

The sculpture molding kit further comprises various accessories 200 to enhance the appearance of the sculptures. In one embodiment, decorations such as eyes, nose, arms, hats, clothes, wings, sunglasses, clothing, and the like may be provided.

Additionally, the sculpture molding kit further comprises various tools to reduce the effort of the user in making the sculpture. In one embodiment, tools to secure the mold sections 10 to a surface are provided, such as nails and a hammer. Such tools can be used to stake the base section 10 to the surface using the base securing structures 20. Additionally, in other embodiments tools to allow a user to fill natural material into the mold section are also provided such as shovels or spades.

It should be understood that the embodiments disclosed herein include mold and mold section apparatuses and methods of making sculptures with natural materials. The mold includes a base section having a base width and at least one intermediate section having an intermediate width, where the intermediate width is less than the base width. The at least one intermediate section is detachably attached to the base section with one or more fastening structures. The base section may also include one or more securing structures used to secure the base section to a surface. The base section and the at least one intermediate sections are also provided with a releasable structure each. After natural materials are filled into the mold sections, the releasable structures are disengaged to reveal a sculpture with conditioned natural material.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all changes and modifications that are within the scope of the claimed subject matter.

1. A mold comprising:
a base section having a base width, a base first opening, and a base second opening; and
at least one intermediate section having an intermediate width, and an intermediate second opening, wherein the intermediate width is less than the base width and the at least one intermediate section is detachably attached to the base section with one or more fastening structures.

2. The mold of claim 1, wherein the one or more fastening structures are placed around the second opening of the at least one intermediate section or around the first opening of the base section.

3. The mold of claim 2, wherein the one or more fastening structures are straps.

4. The mold of claim 3, wherein one or more connecting members are placed on each of the one or more fastening straps.

5. The mold of claim 4, wherein the one or more connecting members are magnets, Velcro™, D-ring attachments, zippers, or a combination thereof.

6. The mold of claim 1, wherein the base section has one or more securing structures around the base second opening to secure the base structure to a surface.

7. The mold of claim 1, wherein the base section further comprises a base releasable structure extending between the base first opening and the base second opening.

8. The mold of claim 1, wherein the at least one intermediate section further comprises an intermediate releasable structure extending from an intermediate top to the intermediate second opening of the at least one intermediate section.

9. The mold of claim 8, wherein the at least one intermediate section is detachably attached to the base section such that a base releasable structure aligns with the intermediate releasable structure.

10. The mold of claim 9, wherein the base releasable structure and the intermediate releasable structure are each made of zippers, buttons, snaps, hook and loop tape, or a combination thereof.

11. The mold of claim 1, wherein the base section and the at least one intermediate section is each made of one or more panels, each panel being made of a flexible material.

12. The mold of claim 11, wherein the one or more panels is made of fabric, polyester, polyethylene, nylon or a combination thereof.

13. The mold of claim 1, wherein the mould further comprises a crown section having a crown first opening, and a crown width, wherein the crown width is less than the intermediate width and crown section is detachably attached to the at least one intermediate section with one or more fastening structures.

14. A mold section comprising:
a hollow structure made of one or more panels, the hollow structure comprising:
a first opening;
a second opening opposite the first opening;
a releasable structure extending from the first opening to the second opening; and
at least one of one or more fastening structures placed around the second opening, and one or more securing structures placed around the second opening.

15. The mold section of claim 14, wherein the one or more panels are made of a flexible material such as fabric, polyester, polyethylene, nylon, or a combination thereof.

16. The mold section of claim 14, wherein the hollow structure has a shape of a sphere, cone, cylinder, hemisphere, pyramid, cube or cuboid.

17. The mold section of claim 14, wherein one or more mold sections are detachably attached to each other using one or more fastening structures.

18. A method of conditioning natural materials for sculpting a sculpture comprising:
filling a base section with natural materials, the base section having a base releasable structure;
attaching the base section to at least one intermediate section using one or more fastening structures, the intermediate section having an intermediate releasable structure;
filling the at least one intermediate section with natural materials; and
disengaging the base releasable structure and intermediate releasable structure to reveal a sculpture.

19. The method of claim 18, further comprising securing the base section using securing structures onto a surface.

20. The method of claim 18, further comprising aligning the intermediate releasable structure with the base releasable structure before disengaging the base releasable structure and the intermediate releasable structure.
